(19) United States
(12) Patent Application Publication
(10) Pub. No.: US 2023/0221479 A1
(43) Pub. Date: Jul. 13, 2023

(54) LENSLET-BASED MICROLED PROJECTORS

(71) Applicant: Google LLC, Mountain View, CA (US)

(72) Inventors: Michael Anthony Klug, Austin, TX (US); Bradley Jay Sissom, Boulder, CO (US)

(21) Appl. No.: 18/154,691

(22) Filed: Jan. 13, 2023

Related U.S. Application Data
(60) Provisional application No. 63/299,322, filed on Jan. 13, 2022.

(51) Int. Cl. F21V 8/00; G02B 27/01; G02B 3/00; G02B 13/00

(52) U.S. Cl. CPC G02B 6/003; G02B 27/0172; G02B 3/0037; G02B 13/0095; G02B 2027/0178

(57) ABSTRACT

In a general aspect, a wearable display system includes a microlens array projector including a plurality of elemental microlens relays (EMRs). Each EMR of the plurality of EMRs includes a microLED microdisplay including a plurality of pixels, and is configured to generate a subset of light associated with an image. Each EMR also includes a microlens configured to receive the subset of light from the microdisplay. The system also includes a lightguide, an incoupling element optically coupled with the lightguide, and an outcoupling element optically coupled with the lightguide. The microlens is configured to relay the subset of light to the incoupling element. The incoupling element is configured to incouple the subset of light into the lightguide. The outcoupling element is configured to outcouple portions of the subset of light at a plurality of respective locations along the lightguide, where outcoupled light of the plurality of EMRs represents the image.

### CROSS REFERENCE TO RELATED APPLICATIONS

This a non-provisional conversion of, and claims the benefit of U.S. Provisional Patent Application Ser. No. 63/299,322, filed on Jan. 13, 2022, which is incorporated herein by reference in its entirety.

### TECHNICAL FIELD

This disclosure relates to display devices. More specifically, this disclosure relates to display devices that may be included in a user wearable device, such as augmented reality or virtual reality glasses.

### BACKGROUND

Displays implemented using lightguide eyepieces are increasingly being used in wearable components for augmented reality (“AR”) and virtual reality (“VR”) applications, e.g., AR and VR glasses. Such display systems may be used to produce images within a large eyebox, which accommodates a wide range of interpupillary distances (“IPD”) and eye rotations of users. In such displays, projectors may be used to generate light that sends light into a lightguide. For instance, in prior approaches, a projector converts light from a pixel source (e.g., a spatial light modulator (“SLM”)) into collimated, angularly-varying beams that are fed into a lightguide eyepiece. Such prior projectors may be undesirably large, particularly for wearable display applications. Further, such prior projectors produce only a single external pupil which is placed near or coincident with an incoupling element (“ICE”), such as an incoupling grating (“ICG”), a prism, or a mirror that is integrally formed with or otherwise coupled to the lightguide. This single pupil is an etendue chokepoint which limits system efficiency and may have significant disadvantages for lightguide eyepieces, such as light transmission efficiency, image quality, and undesirably long light transmission track length and projector volume.

### SUMMARY

In a general aspect, a wearable display system includes a microlens array projector including a plurality of elemental microlens relays (EMRs). Each EMR of the plurality of EMRs includes a microLED microdisplay including a plurality of pixels. The microLED microdisplay is configured to generate a subset of light associated with an image. Each EMR also includes a microlens configured to receive the subset of light from the microLED microdisplay. The system also includes a lightguide, an input coupling element optically coupled with the lightguide, and an output coupling element optically coupled with the lightguide. The microlens is configured to relay the subset of light to the input coupling element. The input coupling element is configured to incouple the subset of light into the lightguide. The output coupling element is configured to outcouple portions of the subset of light at a plurality of respective locations along the lightguide, where outcoupled light of the plurality of EMRs represents the image.

Implementations can include one or more of the following aspects or features, alone in combination. For example, the subset of light can be replicated at least three times by the lightguide before it is outcoupled by the output coupling element.

Less than 10% of the subset of light is outcoupled by the input coupling element.

The microLED microdisplay can be located at a distance of less than 15 millimeters from the lightguide.

The microlens can be monolithically integrated with the microLED microdisplay.

A volume of the microlens array projector can be less than 0.1 cubic centimeter.

The microLED microdisplay can be configured to emit light with a brightness of at least 0.5 million nits.

The plurality of EMRs can be arranged in a non-rectilinear pattern.

The plurality of EMRs can be unequally spaced from each other.

The subset of light can include between 5% and 50% of the image.

The input coupling element can include a plurality of separate input coupling element regions. A first input coupling region of the plurality of separate input coupling element regions can have a first shape, and a second input coupling region of the plurality of separate input coupling element regions can have a second shape that is different than the first shape. The plurality of separate input coupling element regions can be regularly spaced. The plurality of separate input coupling element regions can be irregularly spaced.

The lightguide can have a world-side surface opposite a user-side surface, and the microlens array projector can be disposed on the world-side surface.

The lightguide can be a first lightguide, and the wearable display system can include a second lightguide. The second lightguide can be disposed in a coplanar position relative to the first lightguide. The second lightguide can be disposed in a wrapped position relative to the first lightguide.

The subset of light can be one of red light of the image in wavelength range of 590-680 nanometers (nm), green light of the image in wavelength range of 510-570 nm, or blue light of the image in wavelength range of 430-490 nm.

The input coupling element can be one of a diffractive input coupling element, or a reflective input coupling element.

The output coupling element can be one of a diffractive output coupling element, or a reflective output coupling element.

In another general aspect, a wearable display system includes a first elemental microlens relay (EMR) including a first microdisplay configured to generate a first subset of light associated with an image, and a first microlens configured to receive the first subset of light from the first microdisplay. The system further includes a second EMR including a second microdisplay configured to generate a second subset of light associated with the image, and a first microlens configured to receive the second subset of light from the second microdisplay. The system also includes a third EMR including a third microdisplay configured to generate a third subset of light associated with the image, and a first microlens configured to receive the third subset of light from the third microdisplay. The system still further includes a lightguide, and a first input coupling element optically coupled with the lightguide. The first input coupling element is configured to incouple the first subset of light into the lightguide. The system also includes a second input coupling element optically coupled with the lightguide. The second input coupling element is configured to incouple the second subset of light into the lightguide. The system further includes a third input coupling element optically coupled with the lightguide. The third input coupling element is configured to incouple the third subset of light into the lightguide. The system further includes an output coupling element configured to outcouple the first subset of light, the second subset of light and the third subset of light to display the image.

Implementations can include one or more of the following aspects or features, alone in combination. For example, the first subset of light can correspond with a first subset of angles of a field of view of the image, the second subset of light can correspond to a second subset of angles of the field of view of the image that is different than the first subset of angles, and the third subset of light can correspond to a third subset of angles of the field of view of the image that is different than the first subset of angles and the second subset of angles.

The first input coupling element can be configured to incouple light of a first subset of angles of a field of view of the image. The second input coupling element can be configured to incouple light of a second subset of angles of a field of view of the image that is different than the first subset of angles. The third input coupling element can be configured to incouple light of a first subset of angles of a field of view of the image that is different than the first subset of angles and the second subset of angles.

The first subset of light can include red light of the image. The second subset of light can include green light of the image. The third subset of light can include blue light of the image.

The output coupling element can include a plurality of outcoupling element regions.

### BRIEF DESCRIPTION OF THE DRAWINGS

FIG. 1 is a diagram that illustrates a wearable display system having a microlens array projector (“MLAP”), in accordance with an example implementation.

FIG. 2 is a diagram that illustrates a mathematical comparison of a prior projector system and an example MLAP system.

FIG. 3 is a diagram that illustrates re-bounce in a lightguide eyepiece system.

FIG. 4 is a diagram that illustrates a front view and a top-down view of a rectilinear MLAP system with variable re-bounce, in accordance with an example implementation.

FIGS. 5 and 6 are diagrams that illustrate front views of respective non-rectilinear MLAP arrangements, in accordance with example implementations.

FIG. 7 is a diagram that illustrates a top-down view of a MLAP system, in accordance with an example implementation.

FIGS. 8-11 are diagrams that illustrate top-down views of ray trace diagrams for various MLAP projector arrangements, in accordance with example implementations.

FIGS. 12A and 12B are diagrams illustrating top-down views of ray trace diagrams comparing optical track length of a prior projector system (FIG. 12A) and optical track length on an MLAP system (FIG. 12B).

FIG. 13 is a diagram that illustrates a top-down view of a wearable display having a wrapped form factor, in accordance with an example implementation.

FIGS. 14 and 15 are diagrams illustrating top-down views of example wearable displays including MLAPs on a world-side in a co-planar configuration and in a wrapped configuration, respectively, in accordance with example implementations.

FIGS. 16 and 17 are diagrams illustrating example sizes and locations of MLAPs relative to a wearable glasses frame, in accordance with example implementations.

FIG. 18 is a diagram illustrating a front and a top-down view of a MLAP system configured to provide light of an image to both a viewer's left eye and right eye and having a single shared backplane, in accordance with an example implementation.

FIG. 19 is a diagram illustrating front views of example MLAP systems relative to backplane layout, in accordance with example implementations.

FIG. 20 is a diagram illustrating a top-down view on an MLAP system including diffractive coupling elements, in accordance with an example implementation.

FIGS. 21A-21C are diagrams illustrating an MLAP system including reflective coupling elements, in accordance with an example implementation.

Like reference symbols in the various drawings indicate like elements. Reference numbers for some like elements may not be repeated for all such elements. In certain instances, different reference numbers may be used for like, or similar elements. Some reference numbers for certain elements of a given implementation may not be repeated in each drawing corresponding with that implementation. Some reference numbers for certain elements of a given implementation may be repeated in other drawings corresponding with that implementation, but may not be specifically discussed with reference to each corresponding drawing. The drawings are for purposes of illustrating example implementations and may not necessarily be to scale.

### DETAILED DESCRIPTION

The techniques and approaches described herein provide for producing smaller projectors with higher incoupling efficiency and reduced optical track length than prior projectors, while facilitating a large eyebox for displayed images in associated systems. In example implementations, the projectors disclosed herein enable implementation of lighter weight, more compact, more power-efficient, and lower cost wearable components for augmented reality (AR) and virtual reality (VR) displays.

For instance, the present disclosure provides examples of compact projectors capable of conveying more light into a lightguide eyepiece than prior projectors. Systems using the disclosed projectors in combination with pupil expanding lightguides advantageously generate a large eyebox and high-quality images for a viewer. One aspect of disclosed implementations is use of a lenslet (microlens) array instead of a single-axis, multi-element, usually single-pupil, projection lens, as in prior approaches. Each lenslet in the lenslet array is configured to convey a subset of the total pixels present within a full image into a waveguide through its own distinct, respective pupil. Since each lenslet conveys only a subset of the angles comprising a total field of view of a corresponding system, such lenslet based designs may be simpler than prior projectors using a single large lens arrangement, such as complex lens stacks, for conveying all image display angles from a single display pixel array through a single pupil.

Further, as the example display systems (projectors) disclosed herein may include a lightguide, they are different from systems that are used to accomplish free-space projection onto a screen. For example, in systems directed to free-space projection, the angular distribution of quasi-collimated beams associated with each pixel cross a common pupil and, in fact, the beams define the pupil collectively. In display system using a lightguide eyepiece, such as those disclosed herein, subsets of pixel rays may be produced which do not collectively define a common pupil, but when these subsets of pixel rays are coupled into a pupil expansion lightguide eyepiece (e.g., exit-pupil-expander (EPE), a common eyebox (an expanded pupil) is formed. An eye (of a viewer) positioned within the eyebox may then interpret all subsets of pixel rays as emanating from their proper positions and their proper angular orientations, so that the full image field of view is accurately perceived by the viewer.

This de-coupling of the projector pupil input to the lightguide and the viewer pupil (e.g., the eyebox) exiting the lightguide enables combinations of pixel groups, projection optics and incoupling elements (input coupling element, incouplers, etc.) that may provide several advantages. Prior projectors with a single aperture optical layout require a trade-off between system volume and projected light flux caused by etendue limitations. In contrast, lenslet array projection systems may overcome at least some constraints of prior systems due to the use of an optical multi-aperture setup using arrayed microlenses as projection objectives. In the case of micro-lenslet array projectors (“MLAP”), several separate apertures or pupils are produced and are spatially distributed using relatively low complexity lenses, as compared to prior projectors.

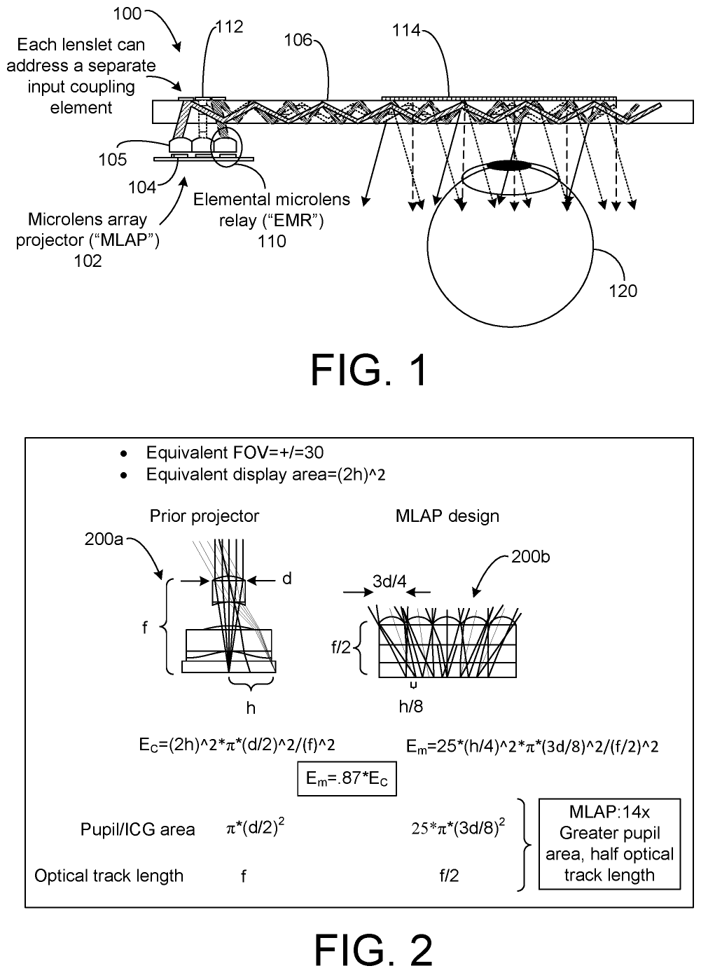

FIG. 1 is a diagram that illustrates a system 100 including a MLAP 102 and a lightguide eyepiece 106. In this example, the MLAP 102 includes a plurality of elemental microlens relays (“EMRs”), e.g., EMRs 110. While the EMRs 110 are shown having equal space between adjacent EMRs 110 (e.g., are regularly spaced), in some implementations EMRs may be differently (unequally, unevenly, etc.) spaced. For example, while the EMRs may be arranged in a regular grid or hexagonal pack configuration, they may also be irregularly spaced or positioned such that the configuration does not have a regular pattern and may be thought of as a constellation of EMR components. Each of the EMRs 110 of the MLAP 102 includes a microlens 105 and an elemental microdisplay 104. The elemental microdisplay 104 may include a plurality of pixels. For a given EMR 110, the microlens 105 is configured to receive light from a corresponding elemental microdisplay 104. Each pixel of the elemental microdisplay 104 may include, for example, one or more microLEDs. For instance, each pixel may include one red, one green, and one blue microLED. Each EMR 110 may be configured to generate and relay light associated with a subset of the total field of view (e.g., a pixel group) to an incoupling element 112 on the lightguide eyepiece 106. Each subset of light may then travel through the lightguide eyepiece 106 until it reaches an outcoupling element 114 (output coupling element, outcoupler, etc.). In some implementations, several outcoupling elements, or an array of outcoupling elements, may be collectively configured to redirect portions of the light out of the lightguide toward a viewer's eye 120 over an area to create an eyebox. When the viewer's eye 120 is located within the eyebox region, the viewer's eye 120 receives light associated with all portions of the field of view.

The use of a self-emissive microdisplay for the elemental microdisplay 104 may reduce volume of the system 100 compared to prior approaches that use an external light source and a spatial light modulator (“SLM”). For instance, micro-LED based microdisplays may enable high brightness with a small volume. In some examples, a microLED microdisplay may have a pixel pitch in a range 1-10 micrometers (um) (or in a range of 2-5 um, or in a range of 0.5-3 um); and each pixel may include a plurality of light emitters (e.g., one red, one green and one blue sub-pixel).

In some implementations, a microLED elemental microdisplay may have a number of pixels in a range 1,000-10,000 (or in a range of 10,000-100,000, or in a range of 100,000-1 million (M), or in a range of 1-10 M). A total resolution of a corresponding display system including a plurality of microdisplays may be approximately equal to the sum of the resolutions of the included microdisplays (e.g., sub-microdisplays). In some implementations, each elemental microdisplay may have lateral dimensions (e.g., width and/or height of a microdisplay area) of less than 10 millimeters (mm) (or less than 5 mm, or less than 4 mm, or less than 3 mm, or less than 2 mm, or less than 1 mm, or less than 500 um). An elemental microdisplay may have a brightness of at least 0.1 million nits Mnits (or at least 0.5 Mnits, or at least 1 Mnits, or at least 2 Mnits, or at least 5 Mnits, or at least 10 Mnits, or at least 50 Mnits, or at least 100 Mnits), where the brightness may be calculated when displaying a substantially white image (e.g., a white image with D65 chromaticity).

Due to the reduced volume of self-emissive microdisplays, as compared to prior projectors, a MLAP (including a backplane, a plurality of microdisplays and corresponding lenses) may have a total volume less than 1 cc (cubic centimeter), or less than 0.5 cc, or less than 0.2 cc, or less than 0.1 cc.

In the disclosed implementations, by subdividing the system field of view, the MLAP architecture enables an etendue versus track length trade-off that was unavailable with previous projectors. This trade-off can also be referred to as a lens design complexity versus track length trade, since aberration correction for smaller fields of view may be achieved using fewer lens elements. A size of an EMR (such as the EMR 110) may be limited by a desired etendue and/or manufacturing design rules. For example, in short track length MLAP's, where a field of view associated with each microlens is a fraction (e.g., 1/9^{th} or less) of the total field of view of the system, each EMR may have a correspondingly smaller etendue. This facilitates a simpler approach to aberration correction when compared with prior projectors, which pass large portions of a field of view, or an entire field of view through a single, complex stack of relay lenses. In some implementations, each EMR of an MLAP may have equivalent aberration correction (for its respective field of view) to such complex lens stacks using fewer, smaller, and/or simpler optical elements.

Additionally, because an MLAP system can be implemented without the use of complex stacks of relay optics, a corresponding total optical track length (e.g., a physical distance between the elemental microdisplay 104 and the incoupling element 112) may be significantly reduced. In addition, as image and field angle information is distributed across several pupils, each pupil may be associated with a distinct (separate) incoupling element. By distributing the light from the MLAP across several incoupling elements, overall display system efficiency may be improved at this critical throughput choke point. Further improvements in efficiency may be made if track length can be incrementally increased.

In some implementations of the system 100 (and other MLAP systems described herein), each EMR of the MLAP 102 may respectively correspond to light of a specific color/wavelength. For instance, a first plurality of EMRs may include microdisplays emitting red light (e.g., in a wavelength range of 590-680 nanometers (nm)), a second plurality of EMRs may include microdisplays emitting green light (e.g., in a wavelength range of 510-570 nm), and a third plurality of EMRs may include microdisplays emitting blue light (e.g., in a wavelength range of 430-490 nm). Incouplers used to couple a specific wavelength/color into a lightguide may be configured for improved efficiency at this wavelength/color, e.g., as compared to other wavelengths/colors. For instance, in this example, a first incoupler can be configured for coupling red light from the first plurality of EMRs into the lightguide, a second incoupler can be configured for coupling green light from the second plurality EMRs in the lightguide, and a third incoupler can be configured for coupling blue light from the third plurality EMRs into the lightguide.

In some implementations, the above approach may be combined with tuning (configuring, producing, etc.) the respective incouplers for angle of incidence. That is, an incoupler may be configured for efficient incoupling of light of a given color/wavelength and incidence angle (or range of incidence of incidence angles). Separating incouplers by wavelength may lead to reduced double-bounce loss. In some implementations, an incoupler may receive radiation (e.g., light) distributed as a spectrum whose full-width at half maximum is less than 100 nm (or less than 50 nm, or less than 30 nm), and the incoupler and a thickness of the lightguide are configured to reduce double-bounce loss for the radiation, in some examples, less than 20% (or less than 10%, or less than 5%) of the radiation's power is loss to double-bounce loss at the incoupler. Outcoupling elements may also be configured for efficient outcoupling at respective colors/wavelengths and/or respective incidence angles (or respective ranges of incidence angles). Further segmentation in wavelengths ranges is possible. For instance, a first EMR may emit light with a first peak wavelength (e.g., in a range of 590-610 nm) and be coupled to a first incoupler; a second EMR may emit light with a second peak wavelength (e.g., in a range of 610-630 nm) and be coupled to a second incoupler, where both the first EMR and the second EMR may contribute to the light of the same color (e.g., red in this example).

This can further be combined with separate lightguides for various colors. For instance, a first lightguide may have red incoupler and outcoupler elements, and be coupled to one or several red-emitting EMRs, and likewise for green and blue. In some implementations, one lightguide may carry one color (e.g. red) and another may carry two colors (e.g. blue and green). This may lead to more freedom in choosing lightguide thicknesses, and reducing double-bounce loss.

Referring to FIG. 2, equations are shown that demonstrate the relationship between a prior projection system 200a and an MLAP system 200b in terms of etendue (E), optical track length (f), and pupil area. In the example, etendue (Ec) of the prior projection system 200a is similar to etendue (Em) of the MLAP system 200b, however, the optical track length of the MLAP system 200b is significantly reduced (e.g., approximately half of the optical track length of the prior projection system 200a) and a pupil area of the MLAP system 200b is increased by an order of magnitude compared to the pupil area of the prior projection system 200a. Accordingly, a MLAP system, such as those described herein, can provide size advantages, e.g., reduced physical size of a projector, compared with a previous projection system, while supporting a same field of view, or larger field of view.

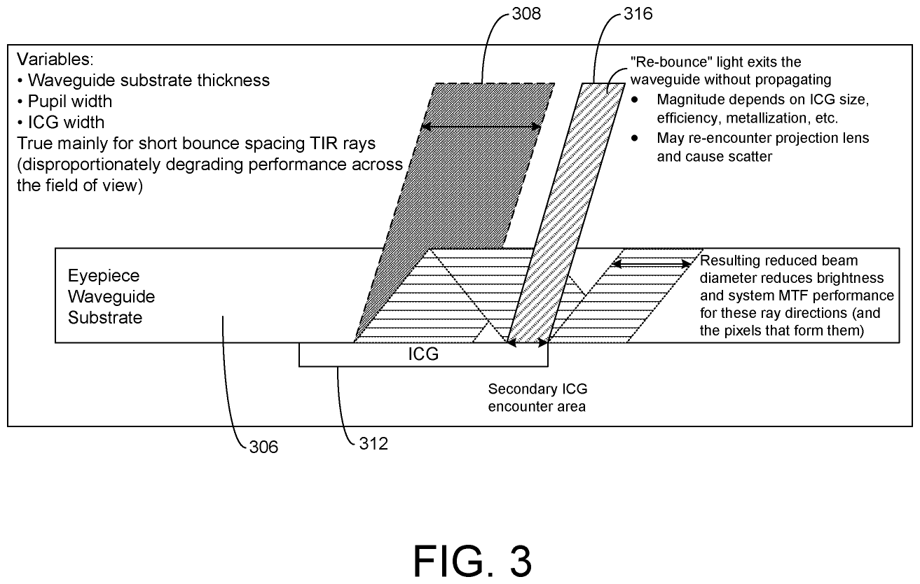

In MLAP systems, EMR location and incoupling element design should be considered due to potential for light re-bounce. Light re-bounce is illustrated in FIG. 3. As shown in FIG. 3, when light 308 intended to interact once with a first incoupling element 312 interacts with the incoupling element 312 a second time within an associated lightguide (lightguide 306), or encounters a second incoupling element (not shown in FIG. 3) along its light path in the lightguide 306, a re-bounce portion 316 of the light 308 may be outcoupled from, or may propagate incorrectly within the lightguide 306 before reaching an intended outcoupling element. Implementations disclosed herein are beneficial for mitigating the problem of “re-bounce”, or re-encountering of the incoupling grating by a launched beam. Such embodiments may reduce or eliminate re-bounce and, as a result, may improve image quality and system efficiency while reducing unwanted stray light within the system. Variables such as lightguide substrate thickness, pupil width, and incoupling element width may be considered when designing EMR and ICE layouts to reduce or eliminate re-bounce.

As noted above, the location of EMR components may not be in a rectilinear grid and may be arranged in a constellation or irregular configuration. To provide additional design freedom in embodiments where the angular distribution of image information over a composite field of view is distributed amongst separate pixel groups and EMRs, the position of those pixel groups/EMRs can be at any suitable location. Each pixel group may correspond to an elemental microdisplay. This location freedom is a result of the lightguide eyepiece's function as a tiling mechanism, which positions a portion of the field of view properly, solely depending on the field angle range associated with pixel information present within the eyepiece lightguide, as demonstrated in FIG. 1. In some implementations, it may be beneficial to adjust spacing of EMRs along a plane parallel to the eyepiece waveguide, so as to minimize spacing between the MLAP and the associated lightguide eyepiece.

De-coupling the image component position (e.g., the location of the EMR) and the pupil position (e.g., the location of the respective pupil projected to the lightguide by each EMR) may provide certain advantages. For instance, since image information within the eyepiece light guide is in the form of parallel quasi-collimated light beams propagating with the correct direction vector in total internal reflection (TIR) within the lightguide and exiting upon encountering an outcoupling element, the spatial positioning of the EMR and the locations at which different image components are launched into the lightguide do not affect the viewer eyebox or the displayed image. The EMR position variable may be manipulated to reduce re-bounce in display systems using MLAP projector configurations.

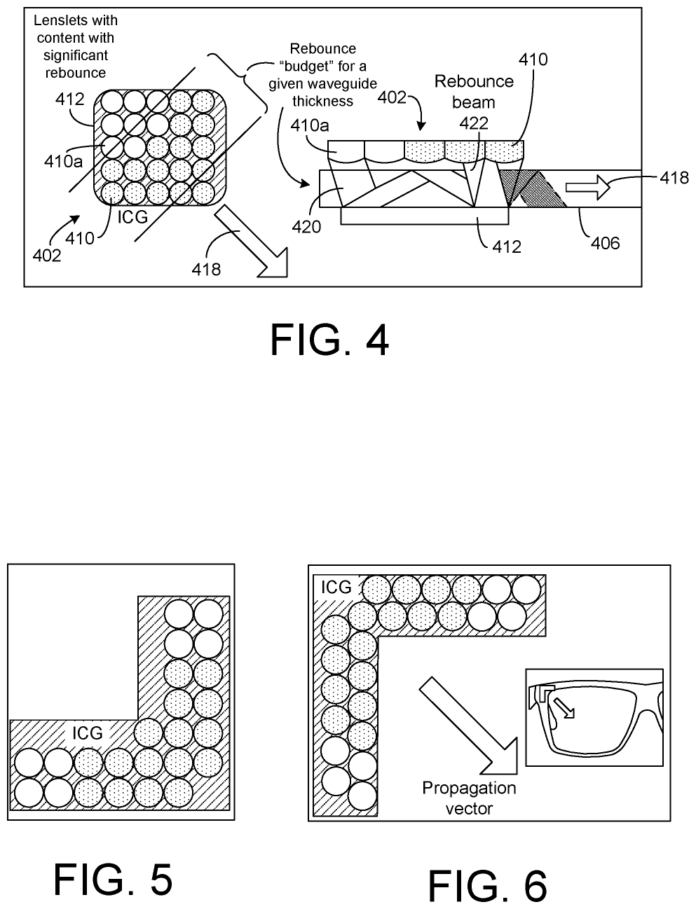

FIG. 4 illustrates how re-bounce can affect an MLAP system. For example, on the left side of FIG. 4, a front view of an MLAP system 402 is shown over an incoupling element 412 (e.g., an incoupling grating (ICG)). On the right side of FIG. 4, a top-down view of the MLAP system 402 is illustrated along with a lightguide 406 having the incoupling element 412 disposed thereon. Incoupling element 412 is configured to receive light from the MLAP system 402 and redirect the light (e.g., along a propagation vector 418) so that it couples into the lightguide 406 where it continues to travel in TIR through the lightguide 406. As shown in FIG. 4, the MLAP system 402 includes a plurality of EMRs 410, each of which is represented by a circle in the front view (left). In some configurations, an MLAP system having EMRs arranged into a grid as shown in FIG. 4 may result in re-bounce as illustrated in the right view and by the re-bounce budget indicated in the left view. For example, EMR 410a directs light 420 to the incoupling element 412. Variables, including the pupil position of EMR 410a on the incoupling element 412, the thickness of the lightguide 406, and the propagation vector 418 at which the incoupling element 412 directs incident light, cause light 420 to interact with the incoupling element 412 twice. At the second interaction, part of the light 420 exits the lightguide 406 as a re-bounce beam 422. In the example shown in FIG. 4, light emitting from EMRs 410 (including the EMR 410a) illustrated as unshaded may experience at least some re-bounce, while light emitted from EMRs 410 may not experience re-bounce.

To reduce or eliminate re-bounce along a corresponding propagation vector, EMRs within an MLAP system may be arranged in non-rectilinear patterns. Further, associated ICEs (ICGs) may be correspondingly configured to capture light from the non-rectilinear arrangement in such MLAP designs. FIGS. 5 and 6 illustrate examples of such EMR and ICG configurations, though more or fewer EMRs may be included within an MLAP system and particular dimensions of the ICG relative to the MLAP may vary depending on the particular implementation. Additionally, while many shape and spacing designs are possible, the examples shown in FIGS. 5 and 6 may be advantageous for wearable display applications because the “corner” or “L-shaped” arrangements can be easily incorporated into a glasses frame without obstructing a user's vision, and without adding significant bulk.

In addition to reducing or eliminating re-bounce, the configurations of FIGS. 5 and 6 provide for the use of an ICE (ICG) with a larger area compared with the ICEs used in prior projector systems. The larger ICE area may provide a higher coupling efficiency for image information (light of a projected image) into the lightguide eyepiece. Further, the MLAP systems of FIGS. 5 and 6 may be segmented into two or more shifted MLAP sub-systems to provide an MLAP footprint/volume to accommodate any mechanical interference or packaging issues for a particular implementation. Accordingly, associated ICEs may also be different sizes and/or shapes. For example, in some implementations, ICEs receiving light associated with a center of a field of view may be larger than ICEs receiving light associated with a peripheral portion of the field of view. Such configurations may improve sharpness of pixels in the center of the field of view. To further improve image quality of the center (or another selected portion) of the field of view, lenslets associated with the center of the field of view may be made from higher quality material and/or with tighter manufacturing tolerances.

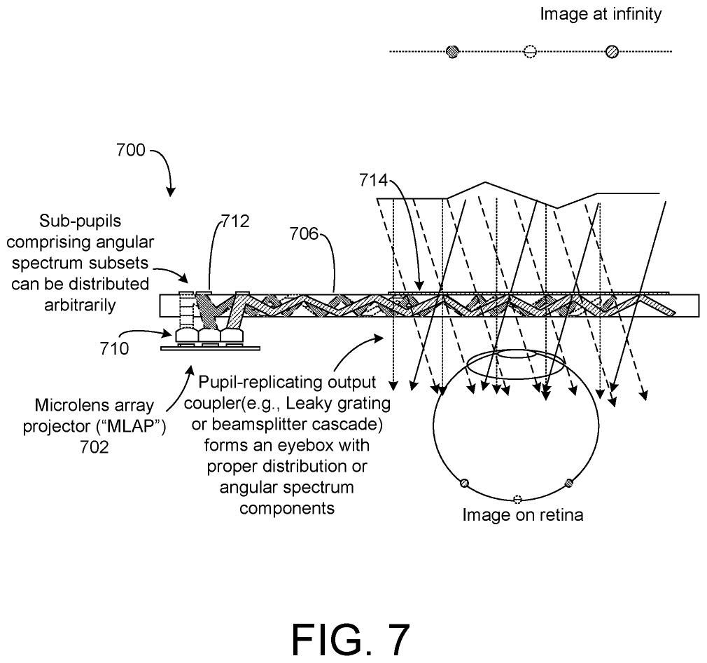

Referring to FIG. 7, a display system (system 700) is illustrated. The system 700 includes an MLAP 702 having a plurality of EMRs 710, a lightguide 706, ICEs 712 (respectively corresponding with each of the EMRs 710), and an outcoupling element 714. Each of the EMRs 710 projects a respective pupil of light containing a subset of the total field angles contained by a single image. The location of each pupil, as well as the location of its corresponding ICE 712, can be laterally distributed to arbitrary positions on the lightguide eyepiece. The outcoupling element 714 (e.g., a leaky output coupler) replicates each sub-pupil within the same space and produces an eyebox through which the percept is a single, coherent image.

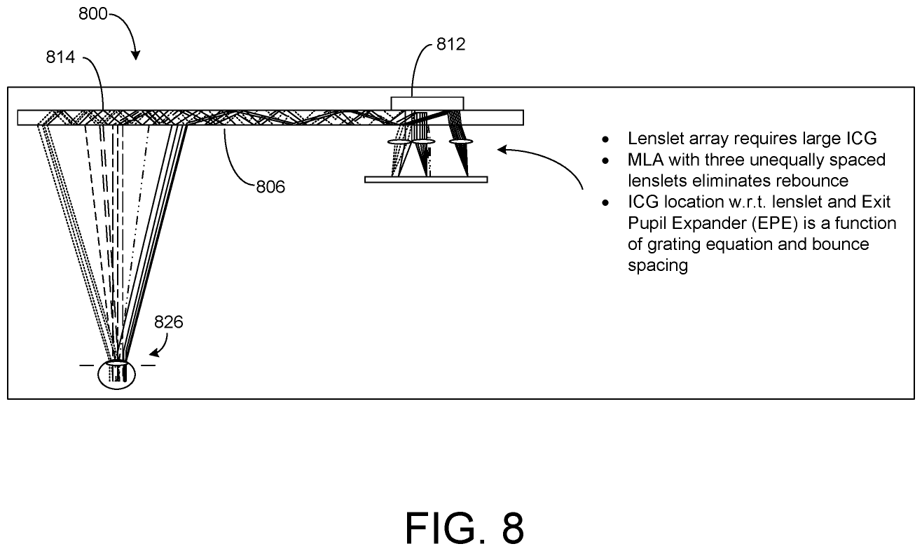

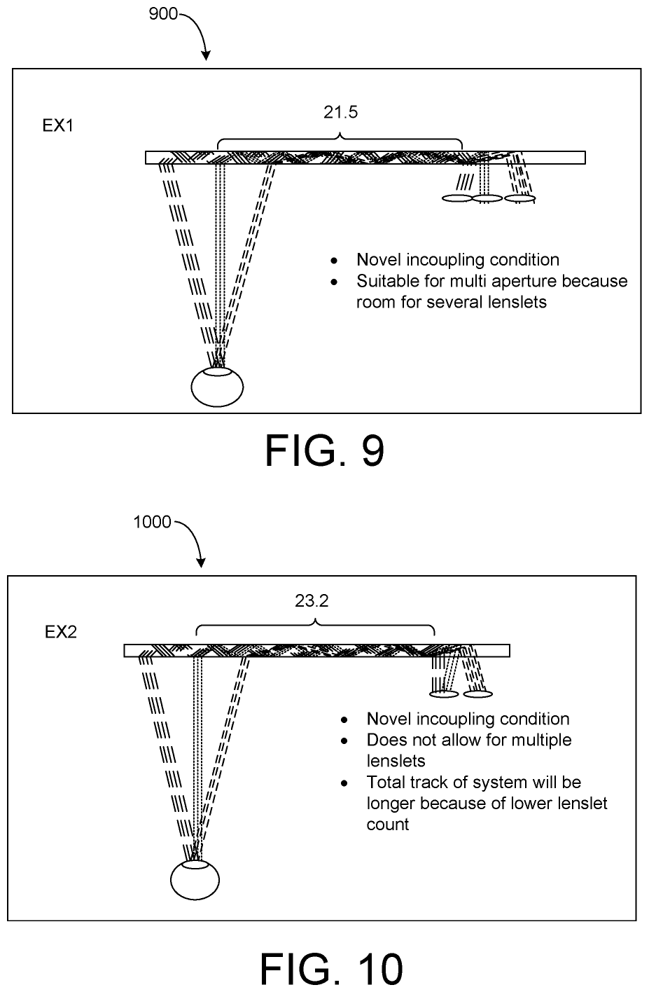

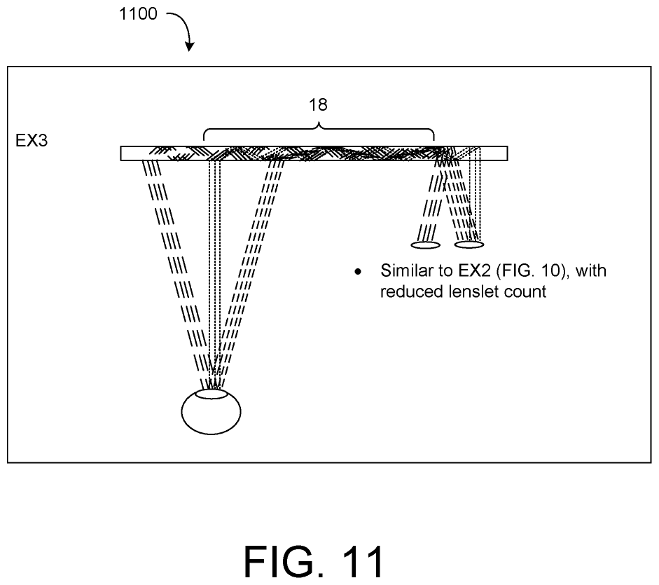

A ray trace diagram 800 is illustrated in FIG. 8. Determining EMR and corresponding ICE position to reduce or eliminate re-bounce may be accomplished by reverse raytracing from a viewer pupil 826 through an outcoupling element 814, lightguide 806, and ICE 812, which can include multiple ICEs. FIGS. 9-11 also show ray trace diagrams 900, 1000, and 1100, respectively. FIGS. 9-11 illustrate three different, respective re-bounce reducing pupil constellations. In these examples, the constellations vary with propagation length although lightguide thickness, which similarly affects corresponding pupil constellations. That is, FIG. 9-11 illustrate how different ray bundles map into different ICGs and EMRs as propagation length varies, where the positions of EMRs may be non-uniformly distributed.

There are additional potential benefits of MLAP projection systems in which each pupil comprises a subset of the angular spectrum of the entire image, and in which each incoupling element acts only on its respective subset of the angular spectrum. In previous imaging systems that generate a single pupil and incouple the single pupil into an eyepiece using a single incoupling element, the incoupling element must be engineered to perform equally well for all incoming beam input angles. This is challenging, especially as more obtuse angles are considered, and thus requires some compromise in the incoupling element (e.g., grating) design to ensure performance uniformity across image angle space.

In an MLAP system, such as those described herein, the image angle spectrum is spatially distributed and subdivided across several lenslets and their associated pupils. Accordingly, each incoupling element (e.g., grating) may be adjusted (tuned, designed, etc.) for a corresponding EMR and its associated angular spectrum. This enables alternative incoupling elements to be considered, which might not have acceptable performance for a full image angle spectrum. For example, in some implementations, volume-phase gratings, which have high efficiency but limited functional angular range may be used and configured for each incoupling element serving a respective angular range subset, thus improving efficiency of the associated system. While a common surface-relief structure used today has the profile of a blazed grating, other surface-relief structures, which also may have significant performance improvement with a more limited angular spectrum, may also be used, such as meta-surfaces and mirrored surfaces with coatings optimized for limited field angles. Accordingly, different designs or categories of incoupling elements may be used on a lightguide depending on characteristics of the light with which it is designed to interact.

In an example implementation, an AR display system includes at least two elemental microdisplays, respectively coupled to (operationally associated with) at least two lenses (lenslets), to form at least two EMRs. Each EMR emits light in a respective angular range around a respective main direction, the directions of the EMRs being different from each other. The respective light of each EMR is optically coupled to a respective incoupling element of a lightguide. Each respective incoupling element is designed to improve the coupling efficiency for light around its respective main direction.

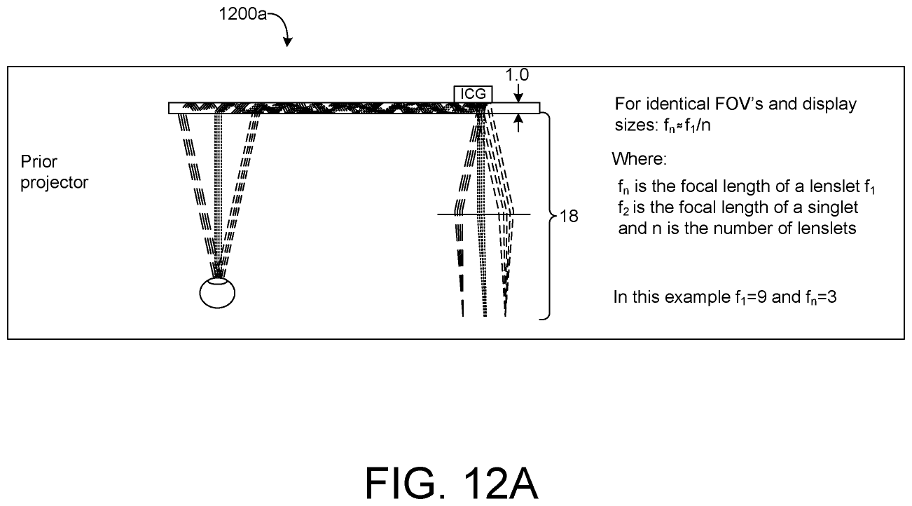

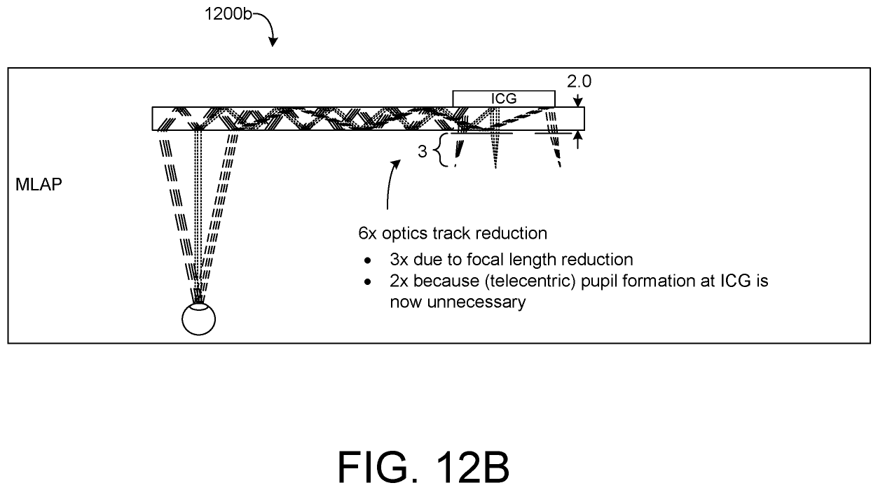

FIGS. 12A and 12B illustrate the relationship of focal lengths in a system having a single lens (FIG. 12A) and focal lengths in a system having multiple lenslets. For instance, FIG. 12A illustrates a system 1200a including a prior projector with a single lens. The system 1200a has a focal length f₁=9. Additional optical track length is required to achieve telecentric pupil formation at the incoupling element. Thus, an optics total track length for the system 1200a is 18 units, or twice the focal length. In comparison, according to an equation quantifying the lenslet focal length as being approximately equal to the singlet focal length divided by the number of lenslets, the system 1200b of FIG. 12B, with three lenslets (e.g., n=3), has a focal length f_{b}=3. Moreover, telecentric pupil formation at the incoupling element is not necessary in an MLAP system. Accordingly, no additional optical track length is required. Therefore, the optical track length for the MLAP system is 3 units, or equal to the focal length. The lightguide thickness of system 1200b may be selected such that re-bounce is reduced or eliminated. Notably, because MLAP systems do not require telecentricity of light entering the lightguide, optical track length may be reduced as compared to prior systems, as is illustrated by FIGS. 12A and 12B (e.g., a 6× track length reduction).

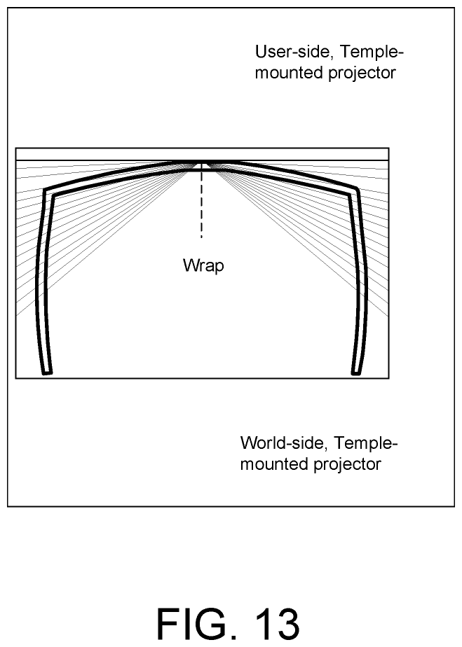

Another potential benefit of MLAP image delivery in combination with leaky grating or beamsplitter cascade lightguide eyepieces is alignment preservation and reduced rigidity requirements for an associated wearable display, such as a glasses system. For larger prior projection systems, placement of the projector is limited by its size, e.g., within or alongside the temple arm of the wearable glasses display, in order to obtain a relatively compact glasses form—factor. This placement, combined with a surface relief incoupling grating or a mirror (in the case of a beamsplitter array type eyepiece) can be highly sensitive to angular displacement of the projector with respect to the lightguide eyepiece. For instance, differential displacement of two projectors, positioned on opposite temples, with respect to their respective eyepieces and to each other, results in a misalignment of left and right eye images (in a binocular wearable case). To mitigate this problem, a rigid frame is commonly employed to hold the eyepieces coplanar to each other and a rigid mounting system is also employed to maintain the projectors' positions with respect to their eyepieces. In some cases, active measurement devices must be used to monitor each eye image and provide compensatory image adjustments if there is any misalignment between them due to relative physical motion of the projectors and eyepieces. In addition, these restrictions practically limit the ability to incorporate a “wrap” form factor into as wearable, e.g., as schematically illustrated in FIG. 13, which is common and desirable in ophthalmic and sunglass spectacles.

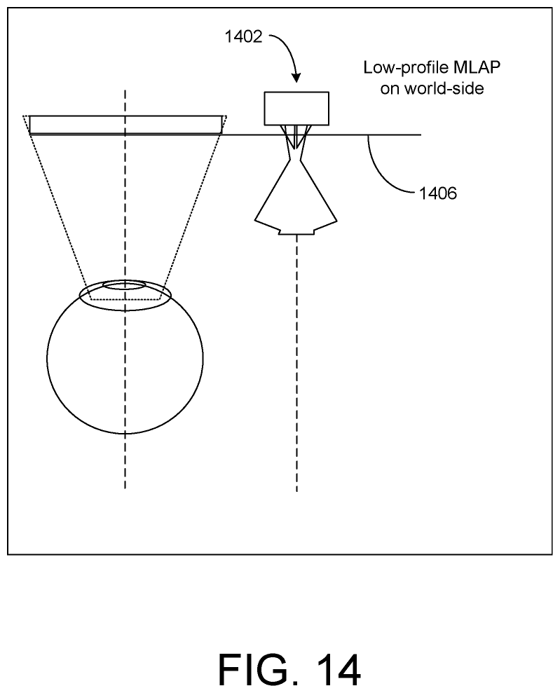

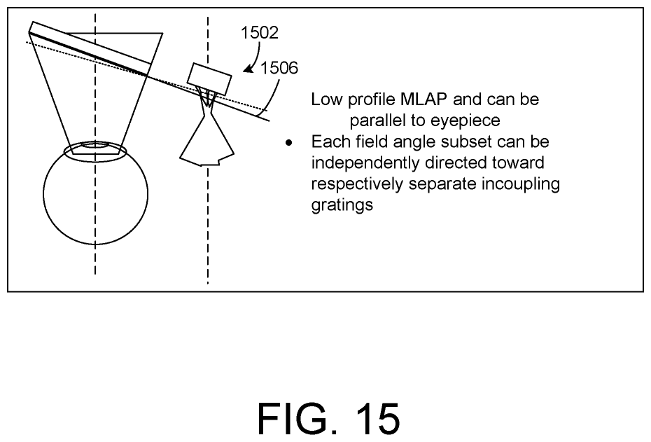

This general class of problems can be mitigated by placement of the projectors on the opposite side of the eyepieces with respect to the viewer (e.g., world side), as illustrated in FIG. 14 (co-planar configuration) and FIG. 15 (wrapped configuration). When the projector is mounted on the world side of the eyepieces (e.g., projecting light toward the user from a side of the eyepiece opposite the user), angular shifts in the projectors do not shift the relative positions of the displayed images in the eyepieces, and alignment can be maintained without expensive active measurement systems or rigid, heavy frames. With prior projectors, due to their size, such placement configurations are not practically aligned with the objective of producing a compact glasses form-factor wearable.

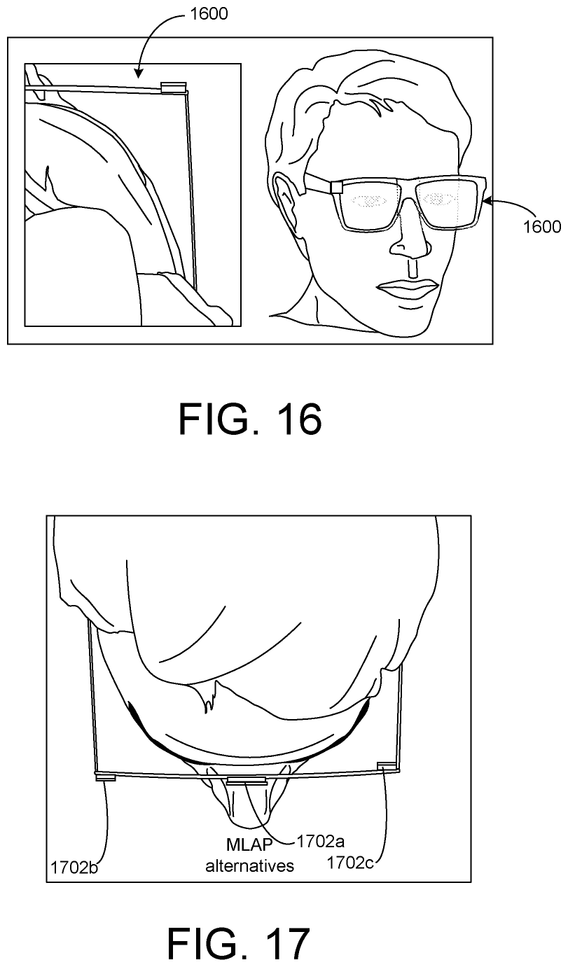

With continued reference to FIGS. 14 and 15, respective MLAP projectors 1402 and 1502 are illustrated on a world side of eyepieces 1406 and 1506, respectively. FIG. 14 illustrates a co-planar eyepiece configuration while FIG. 15 illustrates a wrapped eyepiece configuration. Because of the significantly reduced optical track length and reduced volume achievable with a multi-lenslet MLAP system described herein, the MLAP projector may be located on the world side of the eyepiece without adding significant bulk, weight, or causing wearable balance problems. An illustration of the compact size of the MLAP system 1600 on a world side of a corresponding eyepiece is demonstrated in FIG. 16 in a modeled top-down and perspective view of a user wearing a pair of wearable display glasses.

Additional benefits may be achieved by arranging the projectors in close proximity to each other, such that the magnitude of relative mechanical positional and angular variation between the two projectors is reduced, e.g., as compared to placement at outer portions of the respective lens frames of wearable. In such implementations, MLAP projectors may be placed over the nose of the wearer (e.g., on a glasses bridge) instead of along the left and right temples or at outer corners of the lens frames. With a conventional projector, this configuration results in a bulky, awkward system. Such center-mounted projector arrangements may benefit from a substantially shorter optical track projector, and a shorter optical track projector may facilitate practical implementation of lightweight wearable AR devices.

FIG. 17 is a diagram illustration an example of a center-mounted MLAP 1702a in a top-down view of modeled glasses. FIG. 17 also shows a temple world-side MLAP 1702b and a temple user-side MLAP 1702c for comparison. The MLAP 1702a, the MLAP 1702b, and the MLAP 1702c can operate in conjunction with corresponding lightguide eyepieces and ICEs, such as described herein.

As described herein, MLAP projectors have a shorter track length (in exchange for a larger lateral footprint) than prior projectors. This shorter track length allows for practical placement of an MLAP on the world side of a wearable. In addition, an over-nose placement of an MLAP “pupil constellation” may be accomplished with a single backplane and microLED chip, ensuring alignment and potentially reducing power requirements. In some implementations, such alignment and power requirement reduction may also be achieved using separate backplanes for each elemental microdisplay (microLED chip) of an MLAP system.

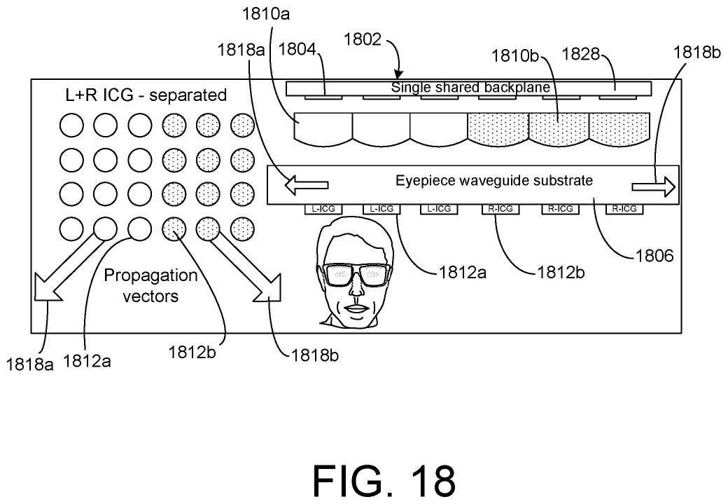

FIG. 18 is a diagram illustrating an example configuration of a wearable display system including a single MLAP 1802 (e.g., such as the MLAP 1702a in FIG. 17) with a single backplane 1828 that serves both left and right eyes of viewer. In this example, the single backplane 1828 drives light emitters (e.g., microLED chips 1804) to generate light that is projected to a plurality of microlenses. A first group of microlenses 1810a direct light to a first group of incoupling elements 1812a on a lightguide 1806. Due to their particular design, the incoupling elements 1812a direct light incident thereon along a first propagation vector 1818a (e.g., to the left in the views of FIG. 18. In some implementations, light traveling in the first propagation direction along the first propagation vector 1818a will encounter a first outcoupling element (not shown) and is then outcoupled from the lightguide 1806 toward a user's left eye. Similarly, a second group of microlenses 1810b direct light to a second group of incoupling elements 1812b on the lightguide 1806. The incoupling elements 1812b direct light incident thereon along a second propagation vector 1818b. In example implementations, light traveling in the second propagation direction along the 1818b//will eventually encounter a second outcoupling element (not shown) and is then outcoupled from the lightguide 1806 toward a user's right eye. Thus, a single backplane, one or more microLED chips 1804, and in some embodiments, a single microlens array can be used to provide light to one or more lightguide eyepieces. Such a configuration is resistant to torsion in the eyepiece support frame and enables lighter, slimmer frame designs.

Another benefit of MLAP designs relates the distribution of a pixel driving area across an associated backplane chip. In the previous projector displays having a single lens, a field of pixels represents the entire image array, and there is a 1:1 correspondence between that field and the field of view of the projection system. A single pupil is produced by the single lens.

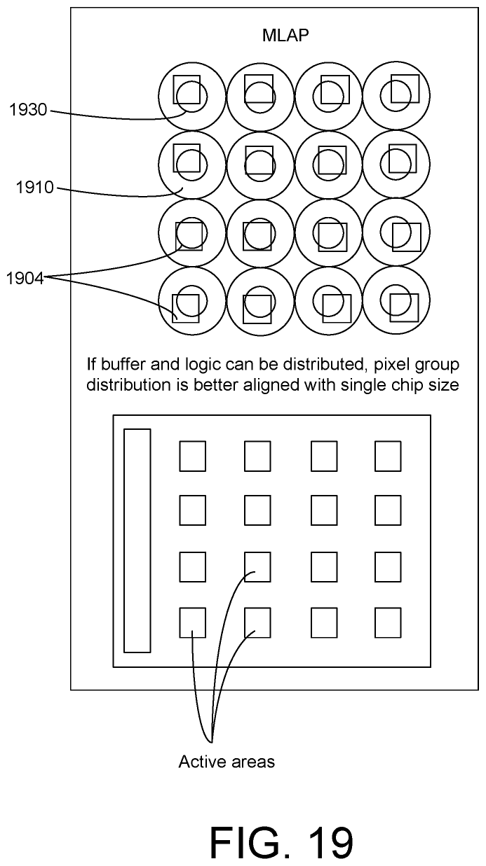

In contrast, an MLAP approach (illustrated in FIG. 19) separates sections of pixels into pixel groups 1904 that are physically distributed laterally. Each pixel group may correspond to an elemental microdisplay (e.g., a microLED microdisplay). A plurality of microlenses 1910 is respectively arranged over the pixel groups 1904, each microlens 1910 may produce a pupil 1930. Notably, each of the pixel groups 1904 does not need to be centered with respect to its associated microlens 1910.

In some implementations, variations of incoupling to a lightguide, and outcoupling elements from a lightguide are possible. Such incoupling elements and outcoupling elements can include diffractive elements (such as surface relief gratings and/or holographic diffractive elements), reflective elements, etc.

As an alternative, instead of using a single monolithic backplane in conjunction with multiple pixel groups, a plurality of backplanes may be used. For instance, each pixel group may be coupled to a corresponding backplane of smaller dimensions than a single monolithic backplane, such as in the arrangement shown in the top view of FIG. 19. This may allow a flexible design (because different pixel groups do not have to be coupled to a same member), a reduced volume, and a reduced use of backplane area.

The distribution of pixels into separate groups may result in better backplane cooling by spreading display emitters over a broader area. It may also result in a better utilization of front-plane wafer real estate, especially when wafer-to-wafer hybrid bonding is used to couple the backplane to the LED layer. In some implementations and approaches including an MLAP, pixel redundancy may also be employed, such that multiple pixels of several MLAP pixel groups may map to a single image pixel. This presents additional potential benefits in aiding to mitigate possible emitter brightness non-uniformities that may be present.

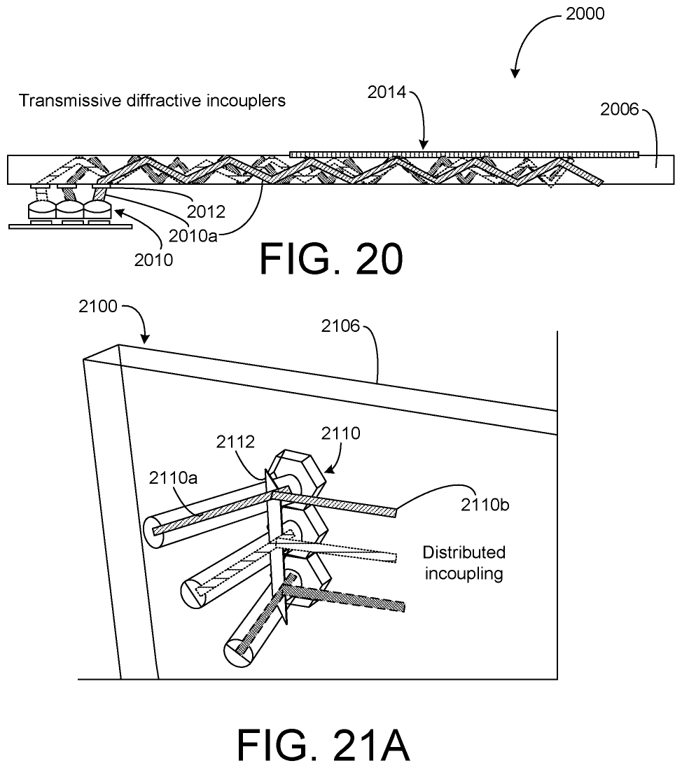

FIG. 20 is a diagram that illustrates an MLAP display system 2000 including diffractive incoupling and outcoupling elements. As shown in FIG. 20, a plurality of EMRs each emit respective light. For instance, an EMR 2010 is illustrated as emitting light 2010a. In this example, the light 2010a from the EMR 2010 is coupled to (transmitted to, incident upon, etc.) a diffractive incoupler 2012. The diffractive incoupler 2012 then diffracts (transmits) the light 2010a (e.g., a least a portion of the light 2010a) into a lightguide 2006. The light 2010a (e.g., the diffracted portion of the light 2010a) then propagates through the lightguide 2006, and is progressively outcoupled by a diffractive outcoupler 2014. Respective light from other EMRs in the MLAP display system 2000 can be similarly incoupled and outcoupled. In addition to these elements, an additional replicating element (not shown) may further provide pupil replication.

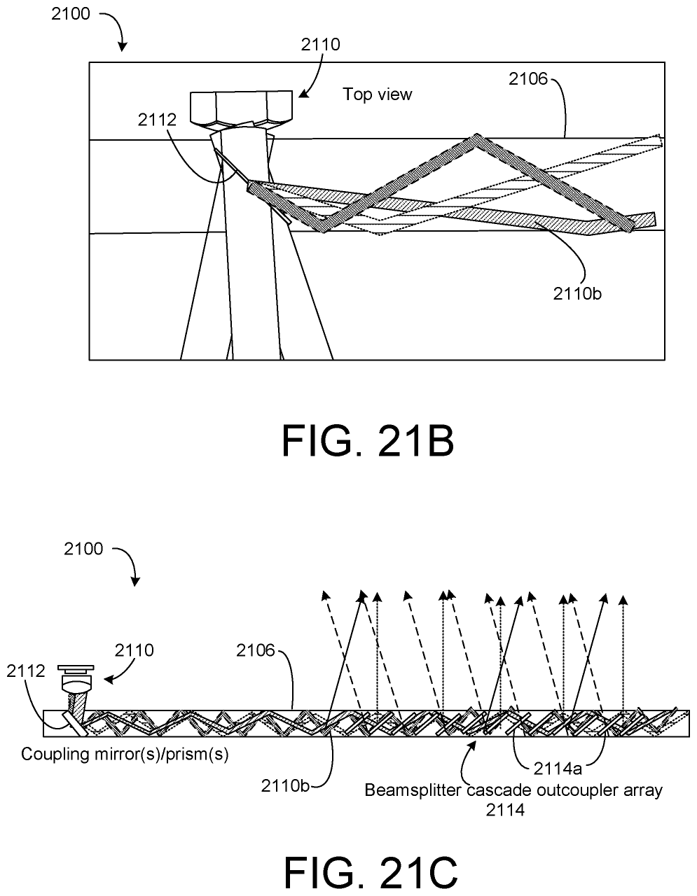

FIGS. 21A-21C are diagrams that illustrate an MLAP display system 2100 including reflective incoupling and outcoupling elements. FIG. 21A shows a perspective view of the MLAP display system 2100, FIG. 21B illustrates a top view of the MLAP display system 2100 (top down in the view of FIG. 21A), and FIG. 21C shows a side view of the MLAP display system 2100. In FIGS. 21A and 21B, an outcoupling element is not shown.

In this example, as shown in FIG. 21A-21C, a plurality of EMRs each emit respective light. For instance, an EMR 2110 is illustrated as emitting light 2110a. In this example, the light 2010a from the EMR 2010 is coupled to (transmitted to, incident upon, etc.) a reflective incoupler 2112. The reflective incoupler 2112 then reflects the light 2110a (e.g., a portion of the light 2110a) as light 2110b into a lightguide 2106. The light 2110b then propagates through the lightguide 2106, and is progressively outcoupled by a reflective outcoupler 2114. In FIG. 21C, light 2110a represents initial light emission by the EMR 2110, and the light 2110b represent the portion of the light 2110a reflected by the reflective incoupler 2112. Respective light from other EMRs in the MLAP display system 2100 can be similarly incoupled and outcoupled.

In some implementations, each EMR of the MLAP display system 2100 can be associated with a respective reflective incoupling element and/or respective outcoupling element, and each reflective element may be configured for a specific angle of incidence and/or wavelength. Referring to FIG. 21C, a plurality of outcoupling mirrors 2114a are shown. In this example, each of the outcoupling mirrors 2114a outcouples a fraction of the light 2110b, while the remaining portion of the light 2110b (e.g., the respective non-reflected portion) continues to propagate through the lightguide 2106, similar to partial outcoupling at each bounce in implementations using a diffractive outcoupler.

In some implementations, the incoupling and outcoupling elements described herein may be combined. For instance, a lightguide may have a reflective incoupler and a diffractive outcoupler, or vice-versa. Further, a reflective element may be beamsplitter-like, e.g., may implement conventional Fresnel reflection (aided by deposition of an optical stack to tune the reflection), or a reflective element may be implemented using a diffractive reflector (e.g. a holographic reflector).

Implementations disclosed herein can include one or more of the following aspects, alone or in combination. For example, light emitted by an EMR may be replicated at least 3 times (or 5 times, or 10 times) by an optical element before being emitted in a viewer's direction. A display system may be configured such that light being emitted by an EMR is incoupled by an in-coupling element, and suffers a double-bounce loss (e.g., outcoupling loss by incoupling elements) that is less than 50% (or less than 20%, or less than 10%, or less than 5%) of the light's incoming power.

An EMR may include an elemental microdisplay that is located at a distance less than 30 mm (or less than 20 mm, or less than 15 mm, or less than 12 mm, or less than 10 mm, or less than 8 mm, or less than 6 mm, or less than 4 mm) from an incoupling element to a light guide.

An EMR may include a microdisplay and a corresponding lens that is formed monolithically disposed on, or monolithically integrate with the microdisplay. For instance, the lens may be molded (e.g., injection molded) on the display; or it may be shaped separately and attached (e.g., glued with a silicone or other adhesive) to the microdisplay. In some implementations, there is no air gap between the microdisplay and the lens. An EMR may include other optical elements (e.g., extra lenses).

Many different implementations are achievable based on the foregoing description and the drawings. It will be understood that it would be unduly repetitious and obfuscating to describe and illustrate every combination and sub-combination of these example implementation. As such, the present specification, including the drawings, shall be construed to constitute a complete written description of all combinations and sub-combinations of the embodiments described herein, and of the manner and process of making and using them, and as supporting claims to any such combination or sub-combination.

The foregoing describes a number of example implementation with reference to the accompanying drawings, in which embodiments of the invention are shown. It will be appreciated, however, that other implementations and configurations are possible, and the foregoing should not be construed as limiting. Rather, the disclosed implementations are provided by way of example.

It will be understood that, although the terms first, second, third etc. as may be used herein to describe various elements, components, regions, layers and/or sections, these elements, components, regions, layers and/or sections should not be limited by these terms. These terms are only used to distinguish one element, component, region, layer or section from another region, layer, or section. Thus, a first element, component, region, layer, or section discussed could be termed a second element, component, region, layer or section.

Spatially relative terms, such as “beneath,” “below,” “lower,” “under,” “above,” “upper,” and the like, as may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in a given figures is turned over (rotated 180 degrees), elements described as “below” or “beneath” or “under” other elements or features would then be “over” or “above.” Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as “between” two layers, it can be the only layer between the two layers, or one or more intervening layers may also be present.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprises” and/or “compromising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items and may be abbreviated as “/”.

It will be understood that when an element or layer is referred to as being “on,” “connected to,” “coupled to,” or “adjacent to” another element or layer, it can be directly on, connected, coupled, or adjacent to the other element or layer, or intervening elements or layers may be present. In contrast, when an element is referred to as being “directly on,” “directly connected to,” “directly coupled to,” or “immediately adjacent to” another element or layer, there are no intervening elements or layers present. Likewise, when light is received or provided “from” one element, it can be received or provided directly from that element or from an intervening element. On the other hand, when light is received or provided “directly from” one element, there are no intervening elements present.

Implementation may be described herein with reference to cross-sectional illustrations that are schematic illustrations of a particular implementation (and/or intermediate structures). As such, variations from the shapes of the illustrations as a result, for example, of manufacturing techniques and/or tolerances, are to be expected. Thus, the described implementations should not be construed as being limited to the particular shapes of regions illustrated herein, but are intended to include deviations in shapes that result, for example, from manufacturing. Accordingly, the regions illustrated in the figures are schematic in nature and their shapes are not intended to limit the actual shape of a region of a device.

What is claimed is:

1. A wearable display system comprising:
a microlens array projector comprising a plurality of elemental microlens relays (EMRs), each EMR of the plurality of EMRs including:
a microLED microdisplay including a plurality of pixels, the microLED microdisplay being configured to generate a subset of light associated with an image; and
a microlens configured to receive the subset of light from the microLED microdisplay, a lightguide;
an input coupling element optically coupled with the lightguide; and
an output coupling element optically coupled with the lightguide,
the microlens being configured to relay the subset of light to the input coupling element,
the input coupling element being configured to incouple the subset of light into the lightguide, and
the output coupling element being configured to outcouple portions of the subset of light at a plurality of respective locations along the lightguide,
wherein outcoupled light of the plurality of EMRs represents the image.

2. The wearable display system of claim 1, wherein the subset of light is replicated at least three times by the lightguide before being outcoupled by the output coupling element.

3. The wearable display system of claim 1, wherein less than 10% of the subset of light is outcoupled by the input coupling element.

4. The wearable display system of claim 1, wherein the microLED microdisplay is located at a distance of less than 15 millimeters from the lightguide.

5. The wearable display system of claim 1, wherein the microlens is monolithically integrated with the microLED microdisplay.

6. The wearable display system of claim 1, wherein a volume of the microlens array projector is less than 0.1 cubic centimeter.

7. The wearable display system of claim 1, wherein the microLED microdisplay is configured to emit light with a brightness of at least 0.5 million nits.

8. The wearable display system of claim 1, wherein the plurality of EMRs are arranged in a non-rectilinear pattern.

9. The wearable display system of claim 1, wherein the plurality of EMRs are unequally spaced from each other.

10. The wearable display system of claim 1, wherein the subset of light includes between 5% and 50% of the image.

11. The wearable display system of claim 1, wherein the input coupling element includes a plurality of separate input coupling element regions.

12. The wearable display system of claim 11, wherein:
a first input coupling region of the plurality of separate input coupling element regions has a first shape; and
a second input coupling region of the plurality of separate input coupling element regions has a second shape that is different than the first shape.

13. The wearable display system of claim 11, wherein the plurality of separate input coupling element regions are regularly spaced.

14. The wearable display system of claim 11, wherein the plurality of separate input coupling element regions are irregularly spaced.

15. The wearable display system of claim 1, wherein:
the lightguide has a world-side surface opposite a user-side surface; and
the microlens array projector is disposed on the world-side surface.

16. The wearable display system of claim 1, where the lightguide is first lightguide, the wearable display system further comprising a second lightguide.

17. The wearable display system of claim 16, wherein the second lightguide is disposed in a coplanar position relative to the first lightguide.

18. The wearable display system of claim 16, wherein the second lightguide is disposed in a wrapped position relative to the first lightguide.

19. The wearable display system of claim 1, where the subset of light is one of:
red light of the image in a wavelength range of 590-680 nanometers (nm);
green light of the image in a wavelength range of 510-570 nm; or
blue light of the image in a wavelength range of 430-490 nm.

20. The wearable display system of claim 1, wherein the input coupling element is one of:
a diffractive input coupling element; or
a reflective input coupling element.

21. The wearable display system of claim 1, wherein the output coupling element is one of:
a diffractive output coupling element; or
a reflective output coupling element.

22. A wearable display system comprising:
a first elemental microlens relay (EMR) including a first microdisplay configured to generate a first subset of light associated with an image, and a first microlens configured to receive the first subset of light from the first microdisplay;
a second EMR including a second microdisplay configured to generate a second subset of light associated with the image, and a first microlens configured to receive the second subset of light from the second microdisplay;
a third EMR including a third microdisplay configured to generate a third subset of light associated with the image, and a first microlens configured to receive the third subset of light from the third microdisplay;
a lightguide;
a first input coupling element optically coupled with the lightguide, the first input coupling element being configured to incouple the first subset of light into the lightguide;
a second input coupling element optically coupled with the lightguide, the second input coupling element being configured to incouple the second subset of light into the lightguide;
a third input coupling element optically coupled with the lightguide, the third input coupling element being configured to incouple the third subset of light into the lightguide; and
an output coupling element configured to outcouple the first subset of light, the second subset of light and the third subset of light to display the image.

23. The wearable display system of claim 22, wherein:
the first subset of light corresponds with a first subset of angles of a field of view of the image;
the second subset of light corresponds to a second subset of angles of the field of view of the image that is different than the first subset of angles; and
the third subset of light corresponds to a third subset of angles of the field of view of the image that is different than the first subset of angles and the second subset of angles.

24. The wearable display system of claim 22, wherein:
the first input coupling element is configured to incouple light of a first subset of angles of a field of view of the image;
the second input coupling element is configured to incouple light of a second subset of angles of a field of view of the image that is different than the first subset of angles; and
the third input coupling element is configured to incouple light of a first subset of angles of a field of view of the image that is different than the first subset of angles and the second subset of angles.

25. The wearable display system of claim 22, wherein:
the first subset of light includes red light of the image;
the second subset of light includes green light of the image; and
the third subset of light includes blue light of the image.

26. The wearable display system of claim 22, wherein the output coupling element includes a plurality of outcoupling element regions.

27. A wearable display system comprising:
a first elemental microlens relay (EMR) configured to emit red light of an image;
a second EMR configured to emit green light of the image;
a third EMR configured to emit blue light of the image;
a lightguide;
a first input coupling element optically coupled with the lightguide, and configured to receive the red light and incouple the red light into the light guide; and
an output coupling element optically coupled with the lightguide,
the red, green and blue coupling optics configured to relay respective red, green and blue lights to respective red, green, and blue input coupling elements,
the red, green, and blue input coupling element being configured to incouple the red, green, and blue lights into the lightguide, and
the output coupling element being configured to outcouple portions of the red, green, and blue lights at a plurality of respective locations along the lightguide.
